(19) United States
(12) Patent Application Publication
(10) Pub. No.: US 2010/0232152 A1
(43) Pub. Date: Sep. 16, 2010

(54) LIGHTING APPARATUS

(75) Inventors: Andrew J. Bankemper, California, KY (US); Charles Lown, Maybrook, NY (US)

Correspondence Address: McDermott Will & Emery, 600 13th Street, NW, Washington, DC, 20005-3096, US

(73) Assignee: LSI INDUSTRIES, INC., Cincinnati, OH (US)

(21) Appl. No.: 12/403,039

(22) Filed: Mar. 12, 2009

(51) Int. Cl. F21V 21/14; F21S 4/00; F21V 19/00

(52) U.S. Cl. 362/219; 362/220; 362/217.1

(57) ABSTRACT

A lighting assembly comprises a body and at least one socket mount pivotably mounted to the body and at least one socket removably secured to the socket mount; the socket mount pivotable between first and second socket mount orientations in which the socket is at least partially located within the body channel in the first socket mount orientation and at least partially located outside the channel in the second socket mount orientation.

### FIELD OF THE DISCLOSURE

The present disclosure relates generally to a lighting apparatus and, more particularly, to a lighting apparatus capable of easily being alternately configured between at least two configurations to facilitate inexpensive and safe storage and shipping in one configuration and full operation and use in a second configuration intended for installation. A method of easy assembly without tools or hardware is also disclosed.

### BACKGROUND OF THE DISCLOSURE

The costs of assembling light fixtures constitutes a significant portion of the overall cost of providing a finished product. Accordingly, reductions in time and operations required to assemble a light fixture will reduce the overall cost of the finished product.

The costs of storing and shipping product also provide significant contributions to the overall cost of providing a finished product to customers. The overall size of an object dictates the space it will consume in a warehouse or in transportation between the manufacturer and the customer. In some instances, the cost of storage and/or transportation may depend, at least in part, on this overall size. In such instances reducing the size of the product stored and shipped to can result in cost savings. One option for shipping large, non-uniform shaped products is to ship the parts of the product or subassemblies to facilitate smaller, more compact shipping. The number of unconnected or loose parts also, however, contributes to the cost of shipping since each unconnected or loose part must be handled and properly packaged in order to prevent damage during shipping.

Damaged goods also contribute to the ultimate cost of providing products to customers. Goods are often damaged during shipping, warehousing, etc. between the manufacturer and receipt by the customer. Accordingly, products designed to withstand the rigors of shipping and warehousing without sustaining damage will reduce the overall costs of providing products to end users.

### SUMMARY OF THE DISCLOSURE

The present disclosure relates to a light fixture facilitating simple manufacture, assembly and shipping to overcome the problems discussed above. In one embodiment, the disclosed lighting assembly comprises: a) a body; b) at least one socket pivotable about a pivot point on the body; c) configured to facilitate (i) a first socket orientation in which the socket is at least partially located within the body, and (ii) a second socket orientation in which the socket is removably securable at least partially outside the body and operable to light the luminaire; and d) the socket is pivotal between the first socket orientation and the second socket orientation.

In another embodiment, the disclosed lighting assembly comprises a body configured to define a channel, at least one socket mount pivotally mounted to the body and at least one socket removably secured to the socket mount; the socket mount pivotable between first and second socket mount orientations in which the socket is at least partially located within the body channel in the first socket mount orientation and at least partially located outside the channel in the second socket mount orientation.

In yet another embodiment, the disclosure includes a luminaire kit comprising a body, a socket and a socket mount, the socket being removably securable to the socket mount by hand without need of tools, the socket mount being removably securable to the body by hand without need for tools such that the socket mount may be pivot between a first socket orientation and a second socket orientation, wherein the socket mount is removably securable in the second socket orientation.

The ornamental shape and design of various disclosed embodiments, as shown in the figures, is also disclosed.

### BRIEF DESCRIPTION OF THE DRAWINGS

The preferred embodiment is depicted in the drawing figures in which like reference numerals refer to the same or corresponding structure and:

FIG. 1 is a perspective view of a preferred lighting apparatus with sockets positioned to receive lighting elements;

FIGS. 2-4 are left-side, top and right-side views, respectively, of the lighting apparatus depicted in FIG. 1;

FIG. 5 is an exploded view of FIG. 1;

FIG. 6 is a perspective view of a socket mount of the lighting apparatus depicted in FIG. 1;

FIG. 7 is a perspective view of an end cap of the lighting apparatus depicted in FIG. 1;

FIG. 8A is a cross-sectional view taken along line 8A-8A of FIG. 2;

FIG. 8B is a cross-sectional view taken along line 8B-8B of FIG. 8A; and

FIG. 9 is a perspective view of the lighting apparatus depicted in FIG. 1 with socket mounts in an alternate position, such as for storage or shipping, and the position of FIG. 1 depicted in ghost lines for reference.

### DETAILED DESCRIPTION OF THE PREFERRED EMBODIMENTS

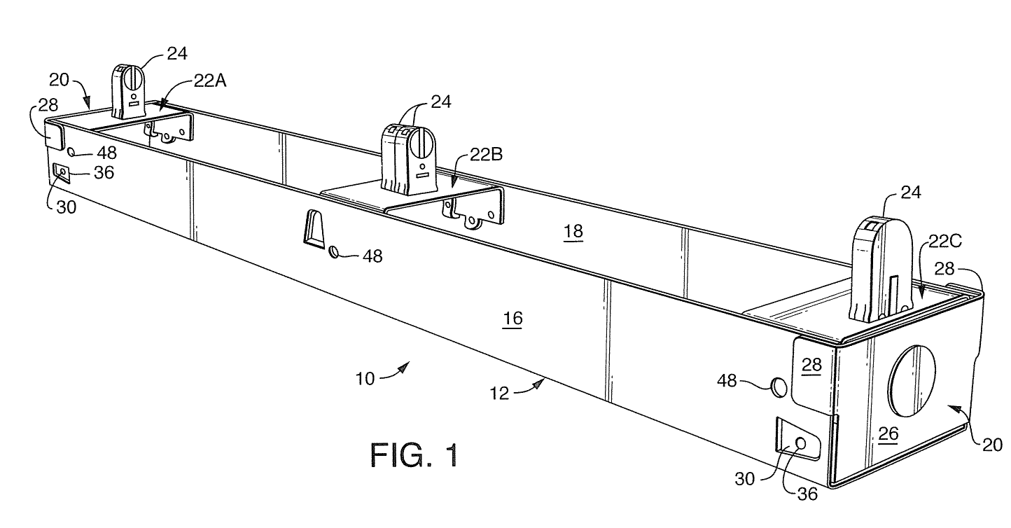

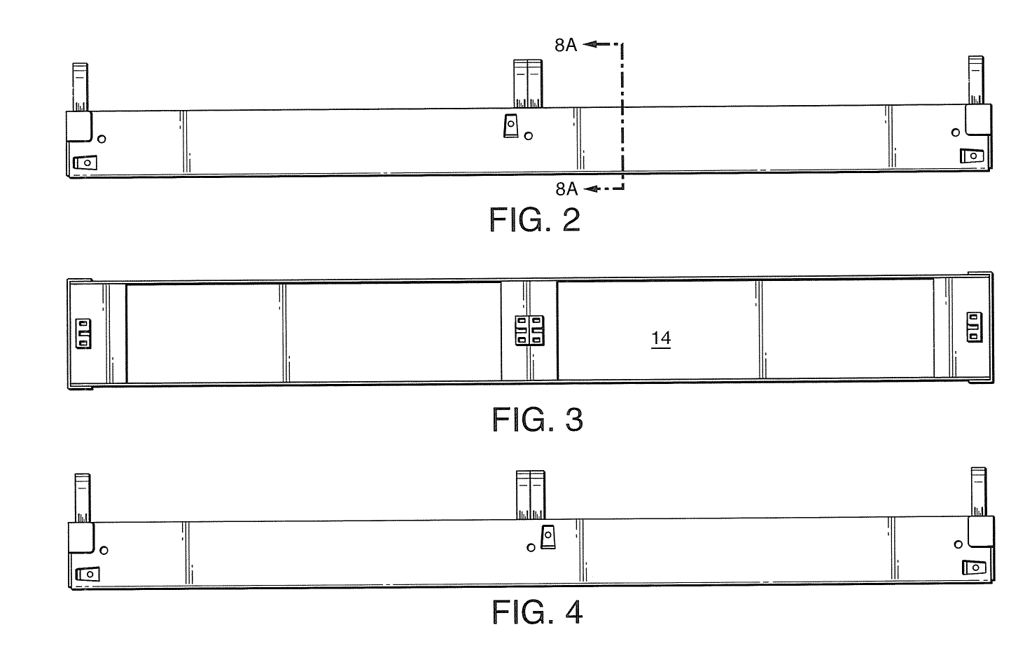

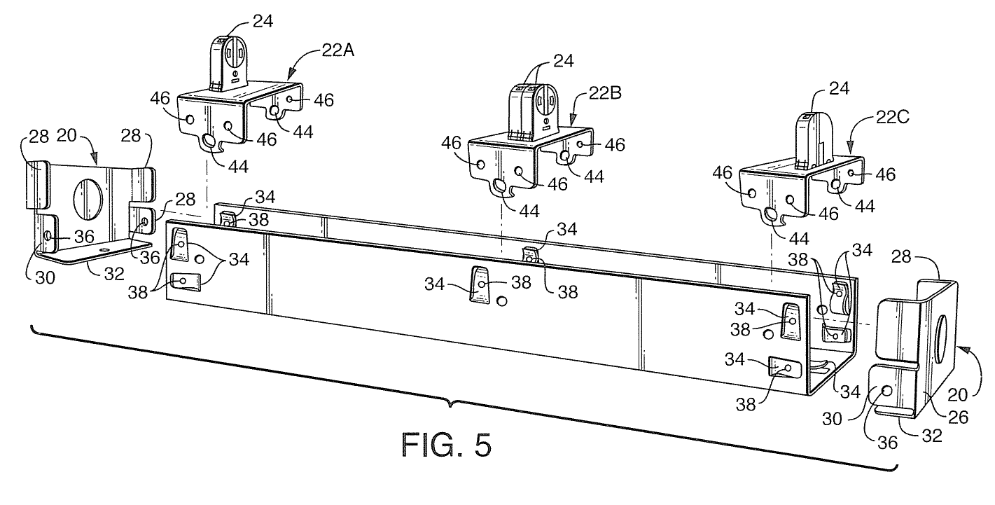

FIG. 1 depicts one preferred lighting apparatus 10 comprising a body 12. In the depicted embodiment, the body 12 is configured to define a channel having a base 14 and opposing first and second body sidewalls 16 and 18. The ends of the channel are optionally, but not necessarily, closed off by end caps 20.

The embodiment depicted in the figures comprises three socket mounts 22A, 22B and 22C on which sockets 24 are mounted. In that embodiment, a single socket 24 is mounted on socket mount 22A, a single socket 24 is mounted on socket mount 22C and two opposing sockets 24 are mounted on socket mount 22B. This embodiment is particularly configured for straight, elongated fluorescent tube lighting elements (not depicted) in which: (1) one such lighting element is connected at its ends, one each, to the socket 24 of socket mount 22A and a socket 24 of socket mount 22B; (2) a second lighting element is connected at its ends, one each, to the socket 24 of socket mount 22C and a socket 24 of socket mount 22B; wherein (3) the lighting elements are aligned along the same longitudinal axis. The lighting assembly can be configured to accept any number of lighting elements aligned along the same longitudinal axis by configuring the length of the body as necessary and inserting the required number of socket mounts and sockets 24. The lighting assembly can also be configured to have any number of lighting elements and corresponding sockets aligned side-by-side or one atop the other.

In the depicted preferred embodiment the sockets 24 are standard sockets for elongated fluorescent tube lighting elements. For example, the sockets 24 can comprise Etlin Daniels socket Model FLO11WS. The disclosed lighting apparatus can alternatively be configured to accommodate any other type of lighting elements by, for example, changing the sockets 24 and corresponding wiring, etc. (not depicted). It is contemplated that the light assembly can be used with incandescent, light emitting diode, organic light emitting diode, compact fluorescent, HID or other lighting.

Each end cap 20 in the embodiment depicted in the figures comprises (as best seen in FIG. 7) an end plate 26, a pair of outer flanges 28 extending from either side of the end plate 26, a pair of inner flanges 26 extending from either side of the end plate 26 and a base flange 32. As depicted in FIG. 1, the outer flanges 28 are configured to locate outside the first and second sidewalls 16, 18 of the body 10. The inner flanges 30 are configured to locate inside the first and second sidewalls 16, 18 of the body 12. The end cap base flange 32 is configured to locate inside the body 10 adjacent the base 14. This inner and outer offset of the flanges locates the end cap 20 with respect to the body 12, keeping the cap 20 and body 12 in the depicted association. The end cap 20 also comprises a circular punch out to facilitate wiring as required for operation and permitted by applicable laws, regulations, ordinances, etc. Other access or mounting hardware, configurations, etc. are contemplated as necessary and/or desired for assembly, installation or operation of the apparatus 10.

The body first and second sidewalls 16, 18 each have a pair of holding tongues 34 located proximate each end of the body 12 and protruding inward of the sidewall 16, 18 from which they extend. Each holding tongue 34 is configured to be displaced from its associated sidewall 16, 18, at its closest, a distance less than the thickness of the end cap inner flanges 30. In this manner, the holding tongues 34 will hold the end cap inner flanges 30, and thus an end cap 20, upon engagement of one with the other. Engagement between the holding tongues 34 and the end cap inner flanges 30 can be a force fit. Engagement may also be provided by a snap-fit, such as by providing (as depicted in the figure) a hole 36 in the end cap inner flange and a corresponding hole 38 in the holding tongue 34. Associations between the two holes 36, 38 can provide a snap-fit facilitating a removably secure connection between the end cap 20 and the body 12. One manner of facilitating a snap-fit association between the two holes 36, 38 is to form one smaller than the other and leave some material extending from the smaller of the holes 36, 38 toward the larger of the holes 36, 38 so that upon alignment, the material of the smaller hole 36, 38 will locate in the lager hole 36, 38. In an alternative embodiment, one of either the holding tongue 34 or end cap inner flange 30 could comprise a dimple to be received in the hole of the other. Other manners of holding the end cap inner flange 30 to the holding tongue 34 are also contemplated and within the scope of this disclosure. One example of a snap-fit configuration is disclosed in co-pending U.S. application Ser. No. 12/248,157 filed Oct. 9, 2008, the entirety of which is incorporated herein by reference. More or fewer holding tongue connections between the body 12 and end cap 20 may be provided. The holding tongue 34 may extend outwardly from the body 12 rather than inwardly and/or be of a different configuration than that depicted in the figures. For greater securement, a rivet, nail or other device can optionally be inserted through the holes 36, 38.

The body 12 may optionally comprise holding tongues 34 located to associate with the end cap base flanges 32. The holding association can be force fit, snap-fit or other as described above for the association between the end cap inner flanges 30 and the holding tongues 34. Other means for holding the end caps 20 to the body 12 are also contemplated.

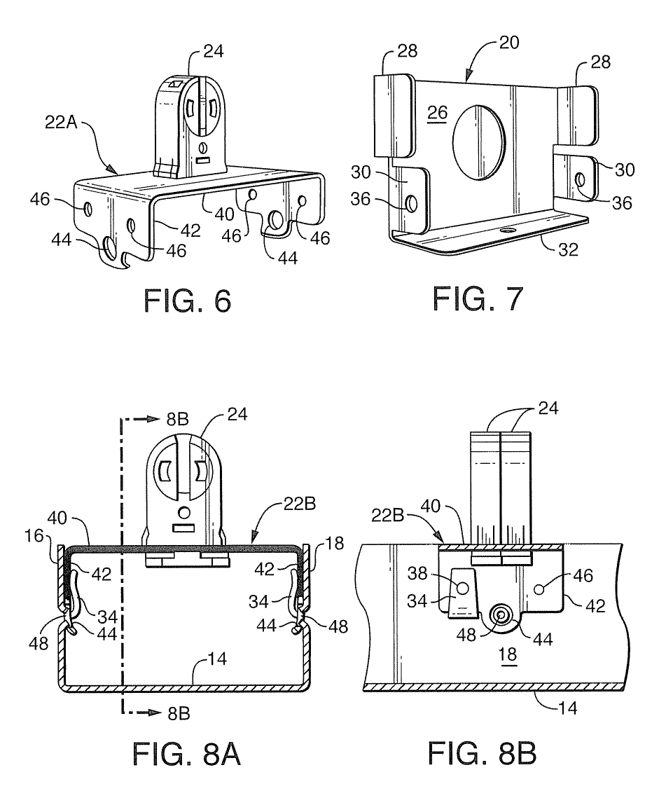

The socket mounts 22A-C (22A is depicted in isolation in FIG. 6) each comprise a top plate 40 with opposing flanges 42 extending from opposite sides thereof. One or more aperture(s) extends through the top plate 40 to accommodate the one or more socket(s) 24 associated therewith. In one preferred embodiment, the sockets 24 slide into and snap into the top plate 40 aperture(s). Each socket mount opposing flange 42 defines a pivot hole 44. The portion of the flange 42 defining the pivot hole 44 and located opposite the top plate 40 is preferably oriented inward toward the opposing flange 42. Adjacent each socket mount 22, the body sidewalls 16, 18 each comprise a dimple, hole or the like extending material inward of the respective sidewall 16, 18 and forming a pivot 48. As depicted, inward orientation of the material defining the socket mount pivot holes 44 allows the flange to be easily directed over the associated pivot 48 on the body sidewalls 16, 18 to locate the pivot within the associated pivot hole 44. With each pivot hole 44 of a socket mount 22 located over an associated pivot 48, a socket mount 22 may rotate about the axis formed by the center of the two pivot holes 44, as discussed further below. Other pivot structures are contemplated, consistent with the objectives of the invention, including placing the dimple, hole or the like on the socket mount 22 and the pivot hole on the body.

Each socket mount opposing flange 42 further comprises a pair of securing holes 46. One of the two securing holes associates with a dimple, hole or the like on an associated holding tongue 34 located on the sidewall 16, 18 adjacent the pivot 48. As particularly called out in FIGS. 8A and 8B, after pivotally mounted to the body 12, the socket mount 22 can be rotated into or out of engagement with the associated holding tongue 34 for force fit, snap-fit or the like, as discussed above with respect to the connection between the end cap inner flanges 30 and the associated holding tongue 34. FIG. 8B depicts the advantages afforded by the symmetry of the socket mounts 22, by showing that one securing hole 46 engages the associated holding tongue 34, while the other does not. However, were the socket mount depicted in FIG. 8B used in the location of socket mount 22C, it would rotate the opposite way to engage the associated holding tongue 34 with the other securing hole 46. This symmetry thus not only reduces the number of different parts, thereby reducing stock costs, but also reduces the complexity, time and costs of assembly. The socket mounts 22 may, however, differ in configuration to accommodate different numbers of sockets 24. For example, the aperture(s) in the top plate 40 of socket mount 22B may be larger or more numerous than that of the top plate 40 of socket mounts 22A, C.

The holding tongues 34 of this disclosure can take many forms consistent with the needs and objectives described herein. Exemplary embodiments can utilize interlocking connections in which a flange, tab or tongue that has been punch-pressed out of a sheet of metal; this flange, tab or tongue can be displaced by a desired distance from the parent sheet of metal. The flange, tab or tongue can be configured and arranged to have a desired angle or angles between the parent sheet. In exemplary embodiments, the flange, tab or tongue can have a dimple or depression/protrusion that can fit within a depression or aperture, e.g., hole, in a mating piece. In exemplary embodiments, SNAPLOCK™ fabricated joints made commercially available by Mate Precision Tooling Inc. with business offices at 1295 Lund Blvd., Anoka, Minn. 55303, USA, can be used for snap-fit connections in accordance with the present disclosure.

Exemplary embodiments of the body 12, end caps 20, and socket mounts 22 may utilize any of the following materials: aluminum, pre-painted aluminum, cold roll steel, hot roll steel, hot roll steel-pickled and oiled, galvanized steel, galvannealed steel, paint grip steel, pre-painted steel, and/or stainless steel. Any suitable finish (e.g., paint or powder coat, etc.) may be used for the housing parts/portions. In the preferred embodiment, the body 12, end caps 20, and socket mounts 22 are all manufactured from sheet metal and all elements of the body 12, end caps 20, and socket mounts 22 are constructed by standard sheet metal forming operations.

The embodiment of the present disclosure depicted in the figures provides lighting assemblies easily assembled by personnel, either at an assembly facility or in the field, without the need for any hardware, assembly tools, or welding for the assembly process. Additional benefits may be provided by eliminating/mitigating needs for machine tooling, assembly equipment and maintenance thereof.

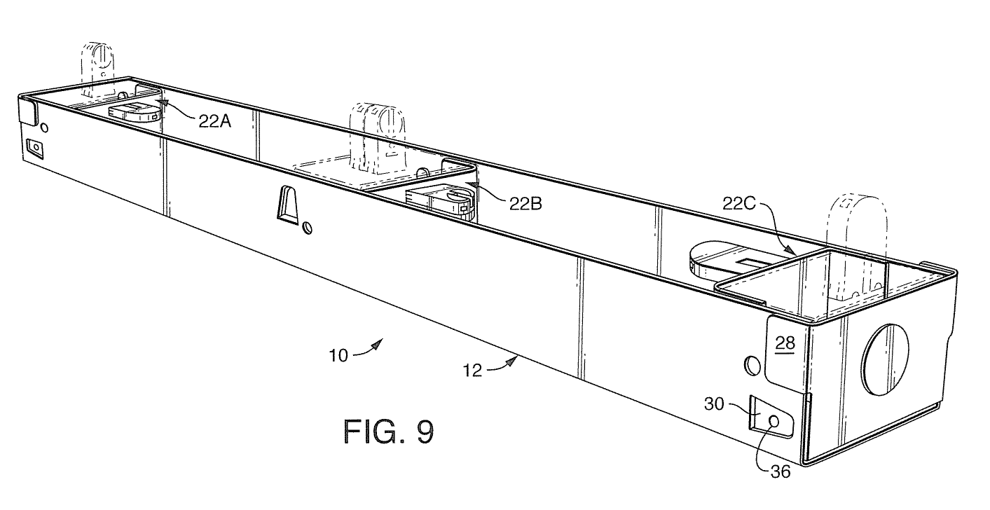

Because assembly is quick and simple, any amount of assembly can be done in the field, thereby leaving the stocking and shipping configuration to be chosen as can be most advantageous. For example, as depicted in FIG. 9, the body 12, end caps 20, socket mounts 22 and sockets 24 and all secured to one another as previously described, except that the socket mounts 22 are pivoted away from their associated holding tongues 34 to lie within the channel defined by the body base 14 and sidewalls 16, 18. In particular, and in no particular order: (1) each socket mount 22 is slid over an associated pivot 48 until the pivot 48 resides within the pivot hole 44, (2) the end caps 20 are slide over the end of the body 12 until the flanges 30, 32 engage with their respective holding tongues 34, and (3) necessary wiring can be connected in the assembly facility or in the field. In this configuration, all parts of the lighting assembly 12 are connected in one subassembly. As depicted in FIG. 9, located within the channel defined by the body 12, the sockets 24 are protected from the harms associated with packing and shipping. Furthermore, moving the sockets 24 into the channel defined by the body 12, reduces the overall size of the subassembly, thereby reducing the space necessary for storage and shipping. Once the subassembly is unpacked, the socket mounts 22 need only be pivoted out of the channel defined by the body 12 until the securely engage the associated mounting flange 34. The lighting assembly 10 may then be placed in its intended environment by know methods and lighting elements installed in the sockets 24.

While the invention has been disclosed by reference to the details of preferred embodiments of the invention, it is to be understood that the disclosure is intended in an illustrative rather than in a limiting sense, as it is contemplated that modifications will be apparent to those skilled in the art, within the spirit of the invention and the scope of the appended claims.

We claim:

1. A luminaire comprising:
a) a body;
b) at least one socket pivotable about a pivot on the body;
c) configured to facilitate (i) a first socket orientation in which the socket is at least partially located within the body, and (ii) a second socket orientation in which the socket is removably securable at least partially outside the body and operable to light the luminaire; and
d) the socket is pivotal between the first socket orientation and the second socket orientation.

2. The luminaire of claim 1 wherein the body is configured to define a channel.

3. The luminaire of claim 1 wherein the body further comprises at least one end cap closing off at least one end of the body.

4. The luminaire of claim 1 further comprising a socket mount pivotally secured to the body, the socket located on the socket mount.

5. The luminaire of claim 4 wherein the body comprises the pivot located in an aperture on the socket mount.

6. The luminaire of claim 1 wherein the socket is located completely within the body in the first socket orientation to protect the socket from damage.

7. The luminaire of claim 1 wherein the socket snap-fits into the second socket orientation.

8. A luminaire comprising a body configured to define a channel, at least one socket mount pivotally mounted to the body and at least one socket removably secured to the socket mount; the socket mount pivotable between first and second socket mount orientations in which the socket is at least partially located within the body channel in the first socket mount orientation and at least partially located outside the channel in the second socket mount orientation.

9. The luminaire of claim 8, wherein the body is configured to define a rectangular shaped channel.

10. The luminaire of claim 8 wherein the body further comprises at least one end cap closing off at least one end of the channel defined by the body.

11. The luminaire of claim 8 wherein the body comprises a pivot located in an aperture on the socket mount.

12. The luminaire of claim 8 wherein the socket is completely within the body in the first socket orientation to protect the socket from damage.

13. The luminaire of claim 8 wherein the socket snap-fits into the second socket orientation.

14. A luminaire kit comprising a body, a socket and a socket mount, the socket being removably securable to the socket mount by hand without need of tools, the socket mount being removably securable to the body by hand without need for tools such that the socket mount may pivot between a first socket orientation and a second socket orientation, wherein the socket mount is removably securable in the second socket orientation.

15. The luminaire kit of claim 14, wherein the socket mount is removably securable to the body by a pivot on the body to which the pivot mount forms a snap-fit engagement.

16. The luminaire kit of claim 14, wherein the luminaire is operable in the second socket orientation.

17. The luminaire kit of claim 14, wherein the socket mount is removable securable in the second socket orientation by pivoting the socket mount into the second orientation to snap-fit engage the body.

18. The luminaire kit of claim 17, wherein the snap-fit engagement between the socket mount and the body is facilitated by a tongue extending from either the body or the socket mount.

19. The luminaire kit of claim 14, wherein the socket is at least partially located within the body in the first socket orientation.

20. The luminaire kit of claim 14 further comprising a second socket mount removably securable to the body, the second socket mount having a socket removably secured thereon.
